(19) United States
(12) Patent Application Publication
(10) Pub. No.: US 2014/0293755 A1
(43) Pub. Date: Oct. 2, 2014

(54) DEVICE WITH FUNCTIONAL DISPLAY AND METHOD FOR TIME MANAGEMENT

(71) Applicant: META WATCH OY, Espoo (FI)

(72) Inventors: Bill Geiser, Dallas, TX (US); David Rosales, Dallas, TX (US)

(73) Assignee: Meta Watch Oy, Espoo (FI)

(21) Appl. No.: 13/852,588

(22) Filed: Mar. 28, 2013

(51) Int. Cl. G04B 19/24

(52) U.S. Cl. CPC G04B 19/24
USPC 368/12; 368/10

(57) ABSTRACT

A device wherein the output dial consists of one or more mechanical display areas and one or more digital display areas, the digital and mechanical display area(s) having connected functions.

### FIELD OF THE INVENTION

The invention is concerned with a device with a functional display and a method for time management.

### BACKGROUND

A display device is an output device for presentation of information in visual^{[} or tactile form (the latter used for example in tactile electronic displays for blind people). When the input information is supplied as an electrical signal, the display is called an electronic display. Common applications for electronic visual displays are televisions or computer monitors.

A lot of different types of displays exist. Some display, like digital displays can show only digits or alphanumeric characters, whereas an analog or mechanical display in meters or watches and clocks presents information in the form of moving pointers.

Generally, a “clock” refers to any device for measuring and displaying the time. The term watch or wrist watch is used for clocks that can be carried on a person's wrist.

Wristwatches are the most common type of watch used today. The first watches were strictly mechanical but along with the progress of technology, the mechanisms used to measure time have often been replaced by the use of quartz vibrations or electronic pulses.

Most inexpensive and medium-priced watches used mainly for timekeeping are electronic watches with quartz movements. Expensive collectible watches, more valued for their workmanship and aesthetic appeal than for simple timekeeping, often have purely mechanical movements and are powered by springs, even though mechanical movements are less accurate than more affordable quartz movements.

In addition to the time, modern watches often display the day, date, month and year, and electronic watches may have many other functions. Watches that provide additional time-related features such as timers, chronographs and alarm functions are also known.

A digital clock is a type of clock that displays the time digitally, i.e. in numerals or other digits or symbols, as opposed to an analog clock, wherein the time is indicated by the positions of continuously moving or rotating indicators, such as hands or pointers. The two or three rotating pointers or hands are pointing to static numbers arrayed on a circular dial.

Digital clocks are often associated with electronic drives, but the “digital” description refers only to the display, not to the drive mechanism and thus both analog and digital clocks can be driven either mechanically or electronically. Consequently, also the name analogue watch refers to the design of the display, regardless of the timekeeping technology used within the watch.

Thus, watch displays maybe analog or digital and sometimes the watches has a display with both analog and digital areas. Such a combined display usually has a little digital window showing the time in numbers inside a normal analog display with pointers for hours, minutes and seconds moving around in an angle of 360°.

Watch displays are sometimes called dials. Generally a dial is generally a flat surface, circular or rectangular, with numbers or similar markings on it, used for displaying the setting or output of a timepiece, radio, clock, watch, or measuring instrument. There are many instruments used in scientific and industrial applications that use dials with pointers as indicators of a specific physical property.

Watches can have alarms designed to wake up a person or be used as a reminder or alert for an event at a specific time.

Alerts may be given in different formats.

Digital alarm clocks often make different noises when giving the alert. Simple battery-powered alarm clocks often make a loud buzzing or beeping sound to wake a sleeper, while newer alarm clocks can speak, laugh, sing, or play sounds from nature. Most modern televisions, cell phones, computer programs or smart phones have alarm clock functions to turn on or make sounds at specified times.

Such devices also can combine calendar events in written form and remind people about a calendar entry a certain default period or a desired time before the event.

The use of time is a developing and changing issue. The allocation of time across a number of activities (such as time spent at home, at work, shopping, etc.) changes with technology, as the television or the Internet has created new opportunities to use and manage time in different ways.

Time management for planning and exercising conscious control over the amount of time spent on specific activities, e.g. for increasing effectiveness and efficiency is important today and may be aided by a range of tool, and techniques used to manage time when intending to accomplish specific tasks, projects and events.

People are increasingly dependent on smart phones and different kind of time pieces and watches for scheduling and for obtaining reminder functions for their time management.

Watches are valued both for their aesthetic appeal and unique design as for its timekeeping and other functions or technology. A trend for example in men's luxury watches are versatile dials having multiple hand movements for performing different functions.

Also solutions for watches that are communicating with mobile terminals exist.

European patent application EP1 758 353 is presented as prior art for a wrist watch-type headset assembly that is wirelessly communicating with a portable terminal.

U.S. Pat. No. 6,556,222 discloses a wearable computing device that can be a wrist watch with a high resolution display for displaying text and graphic items and including a cursor element. The display is capable of wirelessly accessing information from the network and a variety of other devices. The display of the wrist watch has a watch face with digital alarm time indicators corresponding to an hour hand and a minute hand, respectively for setting an alarm notification in hours and minutes via the control of a bezel input-mechanism.

US patent application 2008/0279050 relates to a timepiece with an alert timer, where the users sets a time interval where after the timer will automatically and timely generate an alert signal in a punctual manner.

U.S. Pat. No. 8,185,148 and WO publication 2012/126076 notify the user about events in desired or different formats and also US patent application 2011/0279269 allows the user to create various types of alerts during set up of a given timer.

All prior art solutions focus on alerts on an calendar entry basis even of the three last mentioned publications to some extent allow a modification of the type of alert in a certain format as mentioned above.

### OBJECT OF THE INVENTION

The object of this invention is a display device with user friendly functions.

A special object is a wrist-worn device, like a watch, with efficient user-friendly time management functions.

### SUMMARY OF THE INVENTION

The invention is mainly characterized by the features of the main claims.

The preferable embodiments are presented in the sub claims.

Thus the content of the claims are referred to as being a part of the specification and application text.

The device of the invention has an output display consisting of one or more mechanical display areas and one or more digital display areas, the digital and mechanical display area(s) having connected functions.

In addition to said information display for output to the user, the device of the invention further consists of a microcontroller, means for communication to external devices, a memory, user input means such as buttons or sensors that sense user intent or behavior of the user, and a power source.

The device of the invention can e.g. be a watch, especially a wrist-worn watch, wherein the human information output display consists of both one or more mechanical (or analog) and digital display areas. The total sum of mechanical and digital display areas that the user can read can be referred to as the “dial” of the device or watch.

The digital and mechanical display area(s) have connected functions meaning that they can be synchronized and/or coordinated to operate in unison (or in sync).

The device of the invention can have software itself for the inventive function applications such as the calendar function being a program residing inside the watch or alternatively on a wirelessly-connected mobile station or terminal, such as a smart phone, via which the watch is in connection.

The calendar function used in the invention comprises a system of organized days by means of periods of time, i.e. days, weeks, months, and years. A date is the designation of a single, specific day within this a system. The calendar function further includes software to remind the user of upcoming events, including activities, tasks and/or appointments, which are stored in the database of the calendar function e.g. in the form of a list of planned events in a chronological order by means of a scheduling algorithm with rules to help the person wearing the watch to manage appointments and meetings by means of a new type of alerts or reminders.

The dial of the watch is composed in a new inventive way.

The dial comprises most preferably at least one digital display part and can optionally include one or more mechanical display parts, wherein the mechanical display allows for bi-directional controlled movement of a pointer that can be mounted either at the edge of the watch dial, through a hole in the watch dial, or beneath a transparent watch dial. The mechanical display part can be programmatically controlled and can move dynamically, at any speed needed, to any position needed.

A dot matrix display is a useful display to be used in the invention, wherein the display consists of a dot matrix of lights or mechanical or electrically switched indicators arranged in a rectangular or other configuration such that by switching on or off selected lights, text or graphics can be displayed. A display controller converts instructions from the processor of the watch into signals which turns on or off lights in the matrix so that the required display is produced.

The dial for presenting information to the user comprises of one or more mechanical display parts controlled in conjunction with one or more digital display areas.

A mechanical display pointer can sweep a full circle or a partial circle which is used to direct the user's attention to the correct point of the digital display to understand the output. These pointers or “hands” in the mechanical display can represent information in many advantages ways, either by giving the user an estimate of area by using the pointer to divide a whole or partial circle, by showing overall scale through slow or fast movement, or by pointing specifically to a value on the scale that represents the value of the measurement or calculation at the time.

The information on the digital display displays the context and metrics for interpreting the mechanical display. For example, if there is 1 mile remaining to your destination, your pointer will point to the digital area that denotes ‘1 mile’, further if there is 10 minutes left until your next appointment, the pointer will point to the area of the circle that denotes ‘10 minutes’.

The inventive combination of the mechanical and digital displays creates a new system by which the meaning of the pointers and the proportion of the circle can change. As the information changes so can the mechanical and digital combination change in concert to impart the knowledge with maximum efficiency to the user.

Further, the display of the watch may have widget parts for some functions. Widgets can display weather forecasts, stock prices, phone and/or watch battery status icons, sports scores, etc. The widgets have the role of an auxiliary application and occupy only a portion of the whole display and can be used to control and change the appearance of elements for operating the software application of the watch or to directly control simple utility functions such as the clock itself or the calendar stored.

The invention enables the design of having multiple watch faces and display layouts.

The invention provides a device and method for efficient display of glance-able using a conjunction of multiple display modalities.

Thus, the invention covers both digital and combinations of mechanical (analog) and digital executions in a new and user-friendly way and has multiple mechanical pointer executions.

In the following some special embodiments of the invention is described.

The area of movement of the mechanical pointer(s) can be designed in different ways. They can e.g. sweep over a full or partial circle area. The fact that in the invention, some or a whole portion of the pointer sweep area is overlapping with the digital display(s) enables the design of very useful synchronized functions of the digital and mechanical display(s). E.g. the information displayed on the digital display by the software program augments and provides additional context for the position and movement of the mechanical pointers.

The device has a mechanical display component in a mechanical display area that consists of one or more mechanical pointers with software controlled movement, speed, and position. In normal operation, the pointer is moved relative to a known position (or location) during the initialization sequence. Over time, the recorded position of the pointer in software may drift away from the actual position due to tolerances, errors, or physical shocks. To compensate, the absolute and true position of each pointer can be at one or more position in the area the pointer sweeps.

If the detection area is a large area or field and not a small detection point, a more precise position of the pointer can be determined by taking multiple measurements of the pointer moving at a known speed through the detection area or field.

This described detection of the absolute pointer position can be periodically made to detect an incorrect position of a pointer so that the position can be recalibrated and the correct position can immediately be corrected. Each pointer can be accurately moved into a position relative to any detected absolute position.

Furthermore, each successive pointer position movement is saved in memory after any detected absolute position to create a software model of the physical position of the pointer. The model of the physical location of the pointer built using multiple successive relative position movements can be checked for accuracy by predicting when the next absolute position measurement is expected to be available after or during an relative pointer movement.

It can be checked whether the software model of the pointer position match the physical pointer position. This can take place either by direct measurement of the pointer in a position contrary to the internal model or by the absence of the detection of the pointer in a position predicted by the internal model. If the software model position and the physical position do not match, the pointer will be moved until measured by an absolute position method where the model can be reset and normal operation can resume.

The movement of the mechanical pointer(s) is bi-directional being capable of articulating in two directions (in one direction and then also the reverse direction) and they can sweep over a full or partial circle area.

Some or a whole portion of the pointer sweep area is overlapping with the digital display(s).

The overlapping of one or more mechanical pointers with one or more digital displays can be achieved via several means including, but not limited to: placing the actuator of the mechanical pointer side-by-side with digital displays, in-between digital displays utilizing any empty space, through a hole cut or drilled into one or more of the displays' area, into a notch cut or drilled into the perimeter of a digital display, placing the mechanical actuator underneath a transparent display, using micro-projection to project the digital display onto the top area of the mechanical pointer, using laser or other non-visible spectrum micro projection to energize a phosphor above the or below the mechanical actuator,

In some configurations, the mechanical pointer(s) can be moved to a position that is non-overlapping with the digital display(s) or into positions known to be unused by the user interface software so that during times that the pointer should not interfere with the reading of the display, this “parked” location for the pointers minimizes the interference in reading the display.

One or more of the digital displays can be dot matrix in configuration or a heterogeneous mix of dot matrix, area fields, color fields, and a collection of segments including but not limited to pictograms, icons, numerals, letters, words, colors, or graphs.

The information displayed on the digital display by the software program augments and provides additional context for the position and movement of the mechanical pointers.

The augmentation and additional context provided by the digital display for the pointer area includes one or more or combination of, but is not limited to:
providing a numerical domain over which the mechanical pointer moves and points to a particular position or location representing a number out of that domain. For example, the sweep area of the mechanical pointer could be labeled from 0 to 100 in one function and then be changed in values from 0 to 10 in another, and in either one, the pointer location will be moved to show the value to be communicated to the user;
providing a list in which the position or location of the mechanical pointer highlights an item from said list. The pointer can be moved to point to different items in the list, or the digital display can move the list while the pointer remains static.
providing the digital equivalent of the information represented by the location of the pointer in the sweep area (i.e. a digital “16” when the pointer is pointing between the 10 and the 20). The user has the ability to see the relative position across the scale, but also to know the exact value represented at the same time.
providing the language or pictogram representation of the mode the pointer is in, such as displaying the words “number of steps today” or a pictogram of a shoe when the pointer location is representing the number of steps taken so far that day;
providing digital area fields to show the logical boundaries between different pointer positions or locations to provide a quick summary of what the pointer's location means. For example, the digital display in certain areas can be highlighted with color or with demarcation lines or boundaries, with or without symbolic labels. For example, one area may represent “normal” while the pointer is within the boundaries of that area, while when the pointer is within the boundaries of another area, it may represent “critical” the user can infer a great deal regarding this combination of pointer position in relation to the digital display's boundaries.
providing major and/or minor scale indices to show the movement of the pointer, for example showing long tick marks for major indexes and short tick marks for minor indexes. The long tick marks may represent wholes (1, 2, 3) or major multiples (10, 20, 30) while the small tick marks may represent fractions of a major tick (0.1, 0.2, 0.3) or single increments of a major multiple (1, 2, 3).
providing visual cues of the change in rate of some measurement by changing the rate of pointer movement over time. For example, the digital display may label the pointer as being “distance to goal”, as you move faster, the pointer moves faster, as you move slower, the pointer moves slower.
providing animations that inform the user of changes to the scale or mode of data the pointers represent. For example, if the initial scale of the pointer is 1-100 and the pointer is pointed at the “90” location, the pointer will be 9/10 of the way around the sweep area. If the scale should change to 1-1000, the pointer will move to the location that represents 9/100 of the sweep area and the digital display can animate the growing or shrinking of the scale and scale marks to show the change to the user in an intuitive way.
providing digital display areas of color or pattern representing different groups of values that any given pointer value may fall into. For example the sweep area of the pointer may be divided into a green field, a yellow field and a red field. The pointer may sweep from values in the green field, to yellow field values, and finally to red field values as the pointer moves with relation to the data. These color fields may, for example, represent good conditions (green), caution condition (yellow), and warning condition (red). The user can at a glance group the current pointer position into one of these groups without the need to know the exact data represented.
providing a digital display feature to make it easier to see the sweep and movement of the pointer over time. For example, the digital display may draw a fill or color area past where the pointer has previously swept or alternatively the color area can be in front of the pointer and as the pointer moves it can “erase” the area. This is especially useful when the pointer is representing data that moves slowly over time and the movement of the pointer is difficult to perceive.

The movement direction and movement speed of the mechanical pointers provide augmentation and additional context to the information presented on the digital display.

Examples of the augmentation and additional context includes but is not limited to:
the pointer(s) moving slowly to denote slow changes over time or to denote changes relative to a large scale over time;
the pointer(s) moving quickly to denote fast changes over time or to denote changes relative to a small scale over time;
the pointer(s) absence of movement to highlight a specific position or location or data point or list item. For example, if the pointer stops movement in a particular position or location, this represents information for the user;
the pointer(s) movement to follow one item or location on the digital display as the digital display changes. For example, if the pointer position or location highlights the number “10” in a digital scale from 0 to 10, but the digital scale changes to show 0-20, the pointer can follow the location for 10 as the digital scale animates. This has the benefit of giving the user the context that the digital display moved or changed but the value of the pointer did not;
the pointer(s) in fixed position to denote the pointer is unused and should not be interpreted in conjunction with the display.

An example of an implementation, wherein the synchronized digital and mechanical displays can be used is a device of the invention with calendar functions and with a dial for presenting user events and activities in a chronological order one or more at a time.

The calendar functions include means for storing a list of events including, but not limited to, personal and professional events, appointments, due dates, to do lists, activities, goals, physical or geographic destinations, navigational actions such as “turn right on main st. in 30 seconds”, reminders, observed or inferred behaviors that are expected to take place such as driving to work every day, durations of activities, events interpreted or inferred from personal data such as a birthday or a suggestion of what time to go to sleep, and events that dynamically change based on updated conditions, and others arranged in a time-chronological order.

The device of the invention may be connected to one or more external mobile terminals including but not limited to a mobile phone or personal computer or PDA, or a network attached storage device via a short range wireless communications link. Said external mobile terminal contains software organizational features, e.g. means for storing events in the calendar function of the mobile terminal in a time-chronological order and a timer reminding of said events with alerts on count-down time basis. The device has means for storing all events derived from the operating system, applications, and programming interface functions of said mobile terminal in a time-chronological order.

The device of the invention is connected directly or via network address translation or Internet protocols, or some other software or hardware based routing and network translation to the internet via a short range wireless communications link, including but not limited to, wireless radio transceiver communication to a wireless route or to a cellular phone tower or through a local area to wide area network routing device such as a wireless hotspot or a mobile terminal or a mobile phone or a mobile phone application or a router.

Furthermore, the device maybe connected to the internet via a long range wireless communications link including but not limited to communications methods incorporating wireless radio transceiver communication to a cellular phone tower or other long range wireless network terminal.

The device of the invention has means for storing all events retrieved, derived, calculated, interpreted, or inferred from the user's own internet located web services and resources, cloud stored information, application services, communication services, electronic mail and messaging services, public data, and the programming interface functions of these in a time-chronological order.

Especially when a device of the invention has a limited storage capacity it can be configured to stores only limited temporally relevant data sets and events received from said mobile terminal, said network terminal, said application, or said web service. Examples of relevant event data sets to be stored in the device include, but are not limited to, the single next event or next few events, a list of events spanning the next minute or minutes, hour or hours, day or days, week or weeks, month or months, etc.

The device of the invention can also contain means for alerting the user and attracting their attention including, but not limited to affecting human body senses through visual alerts, auditory alerts, and tactile alerts.

The device of the invention might alerts the user of important events and changes to events by one or more said alert methods. Examples of important events and changes to events include, but are not limited to, switching from the current chronological event to the next event or changes to the order of the events or events that continued past the estimated end period or new events that are added or events that are removed.

The device of the invention has means for receiving events, event changes, and alerts from the mobile terminal.

The device of the invention has a dial for presenting events on a count-down basis comprising a count-down timing to the next temporally sorted alert event. In this dial, there is used a mechanical display pointer is used and relevant meta data, scale, and context of the event on the adjacent digital display part.

The calendar function comprises a scheduling algorithm with rules for reminding about one or more stored events by means of alerts.

The alerted event can be the next event in time of the chronologically stored events, and showing the event in a form showing the time left until the end of this event, in a form showing the time or distance left until the start of the next event such as “turn right in 50 meters”, in a form showing the time or other quantity left until a calculated goal is reached such as “200 steps until daily goal is reached”.

The device of the invention can furthermore display a list of items to be shown on the digital display with the mechanical pointer pointing to a position that highlights an item on that list. The list item that the mechanical pointer is initially highlighting could be the first item on the list, or the last item on the list, an item denoting a saved position by preference, an item denoting a position chosen by software algorithm, the item that was activated last, or the item that was last highlighted by the user.

The mechanical pointer could be configured to move to highlight the next or previous item position when a user action or movement is interpreted at the user's intent to move the pointer. There can be actions to move forward in the list and/or actions interpreted to move backwards in the list. It is possible to step through the list in only one direction, when the end or beginning of the list is reached, the next user action that would be interpreted to move the pointer past the end or beginning can be interpreted as the intent to move the mechanical pointer to opposite side of the list either by continuing to move in the same direction going all the way around, or by reversing direction back over the whole list to the opposite end.

The actual list may be larger than the displayed area. When the mechanical pointer is moved past the beginning or the end of the list but when the digital display area is changed upon user actions showing intent to move through the list, items can be removed or added to the ends of the list depending on the movement through the list.

The mechanical pointer can be held static, but when user actions that show intent to move through the list instead change the digital display so that the mechanical pointer is highlighting the active item in the list.

The digital display can also provide some visual cue highlight to augment the position of the mechanical pointer including but not limited to, scaling the highlighted item up or down in size, changing the color or shading of the highlighted item, animating the highlighted item, reducing visibility of the non-highlighted items, etc.

User actions that are interpreted as an intent to move the mechanical pointer forward or backwards through the list can be the tilting of the device with respect to gravity in one direction denoting the intent to move forward in the list, and/or tilting in the opposite direction denoting the intent to move backward in the list.

Other user actions that may be interpreted as an intent to move the mechanical pointer forward or backwards through the list is the touching of one touch sensitive area of the device denoting the intent to move forward in the list and/or touching a different touch sensitive area of the device denoting the intent to move backward in the list.

Further user actions that may be interpreted as an intent to move the mechanical pointer forward or backwards through the list can be the pressing of one button denoting the intent to move forward in the list and/or touching a different button denoting the intent to move backward in the list.

Still further user actions that may be interpreted as an intent to move the mechanical pointer forward or backwards through the list is the swiping across an array of touch sensitive areas of the device in one direction to denote the intent to move forward in the list and in the opposing direction denoting the intent to move backward in the list.

Still further user actions that may be interpreted as an intent to move the mechanical pointer forward or backwards through the list is to tap the device with a finger on one side to denote the intent to move forward in the list and to tap device on an opposing side to denote the intent to move backward in the list.

Still further user actions that may be interpreted as an intent to move the mechanical pointer forward or backwards through the list is covering one sensor that detects changes in visible or nonvisible light or covering a light emitter that will deprive a light sensor of visible or non-visible light.

Still further user actions that are interpreted as an intent to move the mechanical pointer forward or backwards can be through computer interpretation of a sequence of visual data taken by an imaging camera or array of light sensitive devices in visible or non-visible light.

Still further, the user actions that may be interpreted as an intent to move the mechanical pointer forward or backwards can be through a rotational encoder that when rotated in one direction. The rotational encoder apparatus can have a knob the user can twist manually. When rotated, a coded signal can be interpreted by software to detect speed of rotation, acceleration of rotation, and position of rotation.

Still further, the user actions that are interpreted as an intent to move the mechanical pointer forward or backwards through the list is the user's finger or hand or other body part or stylus or other pointing device, moving over and through an array of spatial fields that can be used detect the presence of the object and interpreted to calculate distance from the field apparatus, acceleration through the field, velocity of movement, and vector of movement. The spatial field can be an electric field, a magnetic field or a projected capacitance field.

The acceleration and velocity measurements over the time of the user actions that are interpreted as intent to move the mechanical pointer can be used to speed up or slow down the movement of the pointer to match the speed of the movement of the user for a more realistic feeling of control.

The device can contain a user input field apparatus that can detect the presence of the user's hand, fingers or other body parts or other objects without the need for physical contact. The user input field can be an electric field, a magnetic field, or a projected capacitance field.

Changes in the user input field by the user's hand, fingers, or other body parts, stylus or other objects are measured over time and can be interpreted to calculate distance from the field apparatus, acceleration through the field, velocity of movement, and vector of movement.

The dial can have a plurality of fields that cover different adjacent areas of the device. Said multiple fields are used to detect the presence and motion of a user's hand, fingers, or other body parts, stylus or other objects as they move from field to field.

An obstruction to a user input field, such as a shirt cuff or jacket can be detected as the field measurements fail to return to normal after a period of time. This detection can be interpreted as an obstruction that the system should halt further detection, or interpreted as a form of input, or alternatively the field measurements can be recalibrated with the obstruction in place and normal operation can resume.

The watch of the invention has many advantages compared to alert functions in prior art. It tells time, saves time, and keeps you on time being easily understood and therefore very user-friendly. It is a modernized countdown timer synchronized with the scheduling services we use in our daily lives.

It increases focus on what to do next by telling the amount of time left to your next important event thereby facilitating the efficiency of the time to be used with mindfulness. Such a conscious and mindful awareness of coming events and activities helps performing tasks in time and time management in general.

Technically, the alerts are constructed in new way of thinking being aesthetically compelling by leveraging an established trend in the luxury watch market.

Next, the invention is further illustrated by means of some embodiment examples by referring to figures to which the invention is not restricted.

### BRIEF DESCRIPTION OF THE DRAWINGS

FIG. 1 is a block diagram of the communicating components of an example implementation of the invention.

FIG. 2 is signal diagram of a possible scenario illustrating the method of the invention

FIG. 3 shows an example of possible display of a watch of the invention

### DETAILED DESCRIPTION

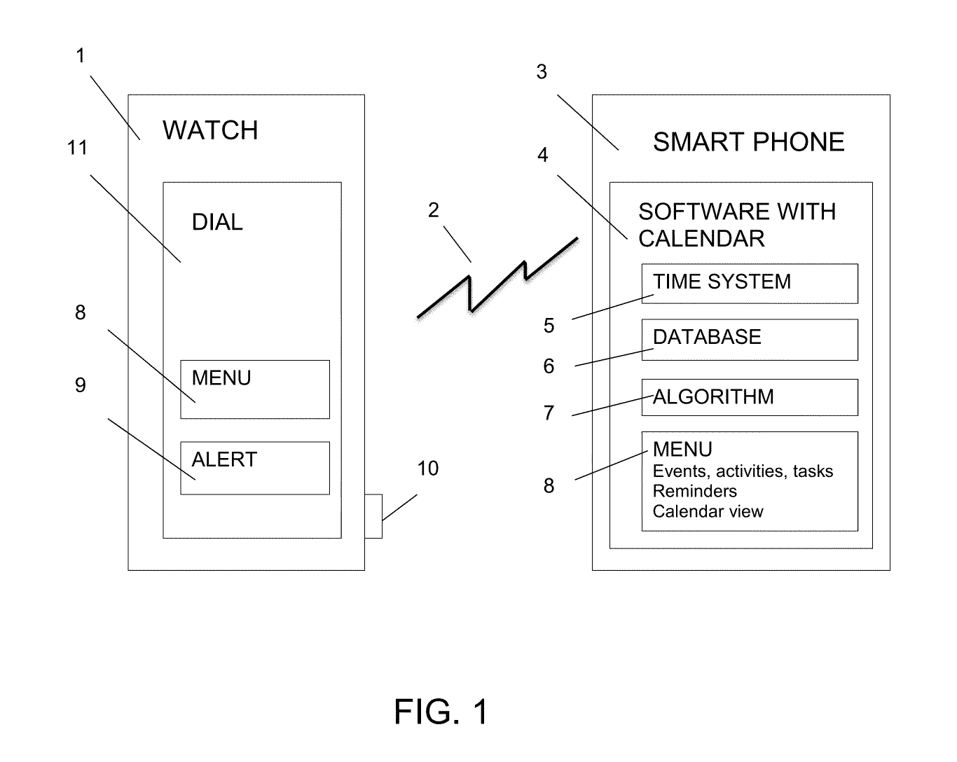

FIG. 1 is a block diagram of the communicating components of an example implementation of the invention. In this example the device of the invention is a watch 1, which is wirelessly connected, e.g. via a Bluetooth connection 2, to a smart phone 3.

The smart phone 3 has software with means for calendar functions 4.

The calendar function used in the invention comprises a time system 5 of organized days by means of periods of time, i.e. days, weeks, months, and years. A date is the designation of a single, specific day within this a system.

The calendar function further includes means 7 to remind the user of upcoming events, including activities, tasks and/or appointments, which are stored in the database 6 of the calendar function 4 e.g. in the form of a list of planned events in a chronological order by means of a scheduling algorithm 7 with rules to help the person wearing the watch 1 to manage appointments and meetings by means of a new type of alerts 9 or reminders. As was mentioned before, the software could be inside the watch 1 as well.

Stored events, such as appointments, activities and tasks, as well as the calendar view and reminders can be controlled and viewed via a menu function 8.

The watch 1 has a button 10 via which the menu of functions can be accessed and seen on the display.

The alert 9 of an event appears on the dial 11 of the watch in a way informing how much time is left for the alerted event to start.

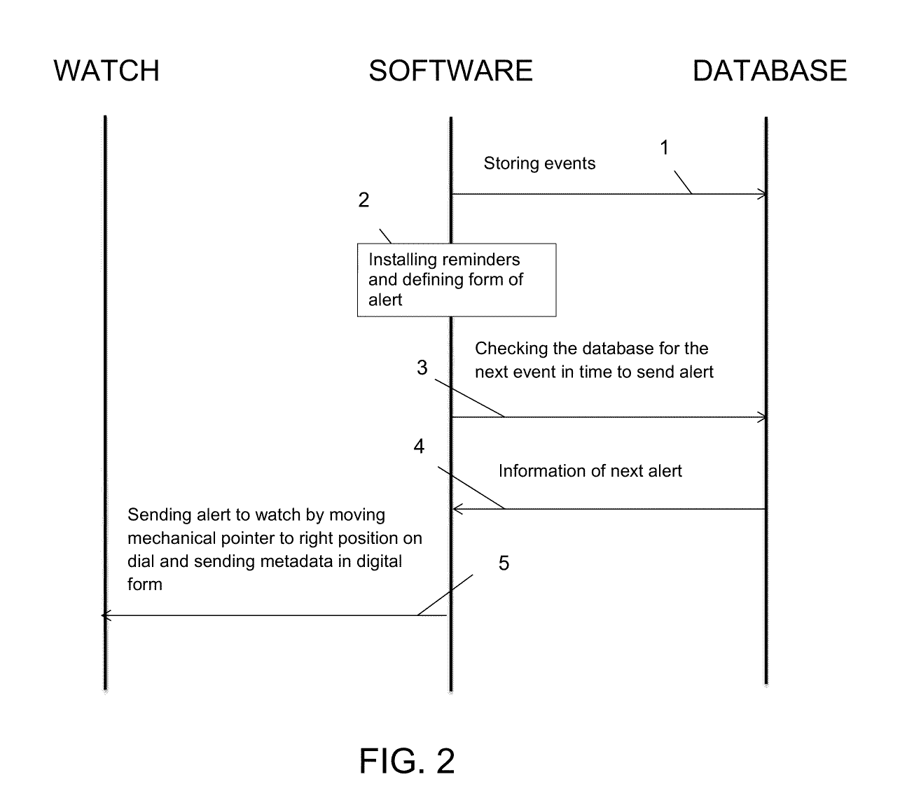

FIG. 2 is signal diagram of a possible scenario illustrating the method of the invention.

As in this example, the calendar functions are installed in a smart phone that is wirelessly communicating with the watch. The user is first in signal 1 storing events in the database of the calendar function in a time-chronological order by means of a software program application. The storing takes place via a user interface of the software in the smart phone.

The software also allows the user to install reminders for some or all events stored and rules for how the alert should be sent, e.g. how much in advance and how many and in which form. These installations are indicated with step 2 of FIG. 2.

The software can keep track of which event is the next in time and to be reminded about by checking the database, the fetch of information being indicated in signals 3 and 4.

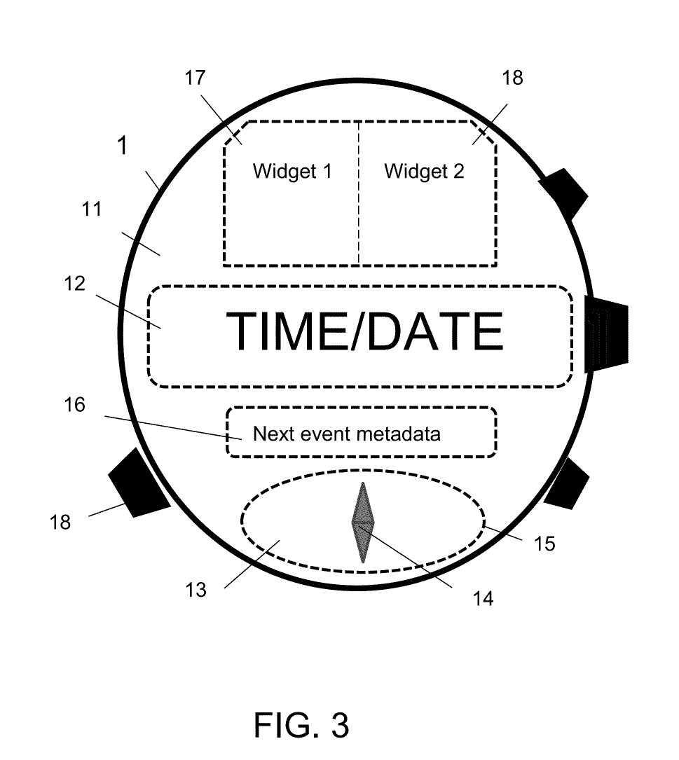

The software then sends an alert of an event that is the next in time to the watch in signal 5, which appears on the dial of the watch. The alert is presented in a form showing the time left until the start of the next event in time. The alert is displayed on the dial of the device by presenting context for the alert on a digital display part of the dial and by showing the time information of the event by means of the position and movement of a mechanical pointer. The form of the alert is presented in more detail in FIG. 3.

FIG. 3 shows an example of possible display 11 of a watch 1 of the invention. The dial 11 comprises at least one digital display part 12 presenting the time and date. The dial 11 also comprises at least one mechanical display part 13, wherein the mechanical display is a single-hand 14 bi-directional gearbox mounted at an edge of the watch dial 1.

The mechanical display part 13 is intended for alerts and can be advantageously constructed in the form of an oval 15 with a pointer 14 moving in a circle for showing the time left for said event to occur. There can be other pointers in the mechanical display for hours, minutes and seconds moving around in an angle of 180°. The half circle display shows the relevant part of the day with respect to the time for said event alerted.

The dial of the watch has a digital display field 16 for metadata of the next event alerted and widgets 17, 18 for some additional functions mentioned earlier. The widgets have the role of an auxiliary application, and occupies only a portion of the whole display and can be used to control and change the appearance of elements for operating the software application of the watch or to directly control simple utility functions such as the clock itself or the calendar stored.

Furthermore, the watch 1 has a button 18 via which the menu of functions can be accessed and seen on the display.

This can be implemented by having each button 18 press to move through a circular menu consisting of the calendar, the events, the reminders and an auto function selecting the next event from the whole event list, thus working as a dedicated button for the next event in time.

1. A device wherein the output dial consists of one or more mechanical display areas and one or more digital display areas, the digital and mechanical display area(s) having connected functions.

2. A device of claim 1, wherein information displayed on the dial is performed by a software program.

3. A device of claim 1, wherein the mechanical display area comprises a component consisting of one or more mechanical pointers with software controlled movement.

4. A device of claim 3, wherein the software controlled movement includes speed, direction and/or position of the pointer(s).

5. A device of claim 3, wherein the absolute position of each pointer is detectable by the software in at one or more positions.

6. A device of claim 3, wherein the absolute position of each pointer is detectable by the activation of a mechanical switch, optical sensor measurement, capacitive sensor measurement, magnetic field sensor measurement, electric field sensor measurement, vibrational measurement, measurement of the electrical properties of the pointer actuator, or time measurement.

7. A device of claim 3, wherein the absolute position of each pointer is periodically detectable to discover an incorrect position of a pointer and for recalibrating the correct position for immediate correction.

8. A device of claim 3, comprising the function of accurate moving of each pointer into a position relative to any detected absolute position.

9. A device of claim 7, comprising the function of saving each successive pointer position movement after any detected absolute position in memory and creating a software model of the physical position of the pointer.

10. A device of claim 9, comprising the function of checking for accuracy the software model of the physical position of the pointer built using multiple successive relative position movements by predicting when the next absolute position measurement is expected to be available after or during a relative pointer movement.

11. A device of claim 10, comprising the function wherein if the software model of the pointer position does not match the physical pointer position, either by direct measurement of the pointer in a location contrary to the internal model or by the absence of the detection of the pointer in a position predicted by the internal model, the pointer is moved until measured by an absolute position method whereafter the software model is reset for normal operation.

12. A device of claim 3 wherein the movement of the mechanical pointer(s) is bi-directional being capable of articulating in two directions.

13. A device of claim 3 wherein the mechanical pointer(s) can sweep over a full or partial circle area.

14. A device of claim 13, wherein some or a whole portion of the pointer sweep area is overlapping with the digital display(s).

15. A device of claim 14, wherein the overlapping of one or more mechanical pointers with one or more digital displays consists of an arrangement, wherein the actuator of the mechanical pointer is placed side-by-side with one or more digital display(s), in-between digital displays utilizing an empty space, through a hole cut or drilled into one or more of the displays' area, into a notch cut or drilled into the perimeter of a digital display, underneath a transparent display, or the digital display being projected by microprojecting onto the top area of the mechanical pointer, or the overlapping consists of a phosphor energized above the or below the mechanical actuator.

16. A device of claim 3 wherein the mechanical pointer(s) can be moved to a position that is non-overlapping with the digital display(s) or into positions known to be unused by the user interface software.

17. A device of claim 3 wherein one or more of the digital displays are dot matrix in configuration or a heterogeneous mix of dot matrix and one or more of the following: area fields, color fields, and/or a collection of segments, such as pictograms, icons, numerals, letters, words, colors, or graphs.

18. A device of claim 3 wherein the information displayed on the digital display by the software program augments and provides context for the position and movement of the mechanical pointers.

19. A device of claim 18, wherein the augmentation and additional context provided by the digital display for the pointer area includes providing the scale of a numerical domain, providing a list of objects to be used for pointing to a selection, providing the numeric or language equivalent represented by the position of the pointer, providing the language or pictogram representation of the mode the pointer is in, providing area fields to show the boundaries between different pointer positions, providing major and minor scale indices, providing speed or acceleration or slope information based on the pointer movement over time, providing animations that inform the user of changes to the scale or mode of data the pointers represent, providing changes in color representing areas of different values the pointer may pass or changes in the pointer position, and/or providing a fill before or after the sweep of the pointer to make it easier to see the movement of the pointer over time.

20. A device of claim 3 wherein the movement direction and movement speed of the mechanical pointers provides augmentation and additional context to the information presented on the digital display.

21. A device of claim 20, wherein examples of the augmentation and additional context includes moving slowly to denote slow changes over time, moving slowly to denote larger changes but over a much larger scale or domain, moving quickly to denote fast changes over time, moving quickly to denote small changes over a small scale or domain, moving with a speed relative to the speed of the measured changes, the absence of movement to highlight a specific location or data point or numeral or icon or list item, pointer movement to match following one item or location on the digital display as the digital display animates to give the user context that the digital display moved or changed but the pointer did not, and the pointer in parked position to denote the pointer is unused and should not be interpreted in conjunction with the display.

22. A device of claim 1 wherein the device calendar functions for storing user events and activities in a chronological order and with a dial for presenting one or more at a time.

23. A device of claim 22, wherein the calendar functions include means for storing a list of events including personal and professional events, appointments, due dates, to do lists, activities, goals, distance over time movement, navigational actions, reminders, observed or inferred behaviors that are expected to take place, next location, navigational route calculations, durations of activities, events based on calculations, events interpreted or inferred from personal data, and events that dynamically change based on updated conditions, and others arranged in a time-chronological order.

24. A device of claim 1 wherein the device is connected to one or more external mobile terminals, or a network attached storage device via a short range wireless communications link.

25. A device of claim 24 with means for storing all events derived from the operating system, applications, and programming interface functions of said mobile terminal in a time-chronological order.

26. A device of claim 1 wherein the device is connected directly or via network address translation or Internet protocols, or some other software or hardware based routing and network translation to the internet via a short range wireless communications link, including but not limited to, wireless radio transceiver communication to a wireless route or to a cellular phone tower or through a local area to wide area network routing device such as a wireless hotspot or a mobile terminal or a mobile phone or a mobile phone application or a router.

27. A device of claim 26 connected to the internet via a long range wireless communications link including but not limited to communications methods incorporating wireless radio transceiver communication to a cellular phone tower or other long range wireless network terminal.

28. A device of claim 22 wherein the device has means for storing all events retrieved, derived, calculated, interpreted, or inferred from the user's own internet located web services and resources, cloud stored information, application services, communication services, electronic mail and messaging services, public data, and the programming interface functions of these in a time-chronological order.

29. A device of claim 22 wherein the device comprises the functions of storing only limited temporally relevant data sets and events received from said mobile terminal, said network terminal, said application, or said web service, such as the next event or the next few events, a list of events spanning a limited coming time.

30. A device of claim 1 wherein the device comprises means for alerting the user and attracting their attention including, but not limited to affecting human body senses through visual alerts, auditory alerts, and tactile alerts.

31. A device of claim 22 wherein the device comprises the function of alerting the user of important events and changes to events such as switching from the current chronological event to the next event or changes to the order of the events or events that continued past the estimated end period or new events that are added or events that are removed.

32. A device of claim 24 wherein the device has means for receiving events, event changes, and alerts from the mobile terminal.

33. A device of claim 1 wherein the device has a dial for presenting events stored in a memory on a count-down basis and a timer for reminding of said events with alerts.

34. A device of claim 22 wherein the calendar function comprises a scheduling algorithm with rules for reminding about one or more stored events by means of alerts.

35. A device of claim 30 wherein the alerted event is the next event in time of the chronologically stored events.

36. A device of claim 33 wherein the dial for presenting events on a count-down basis comprises countdown timing to the next temporally sorted alert event using the mechanical display pointer and relevant meta data, scale, and context for the event on the adjacent digital display part.

37. A device of claim 33 wherein the alert has the form showing the time left until the end of this event.

38. A device of claim 33 wherein the alert has the form showing the time left until the start of the next event.

39. A device of claim 33 wherein the alert has the form showing the time left until a calculated goal is reached.

40. A device of claim 33 wherein the alert has the form showing the distance left until the start of the next event.

41. Device of claim 1 wherein the device can display a list of items to be shown on the digital display with the mechanical pointer pointing to a position that highlights an item on that list.

42. Device of claim 41 wherein the list item that the mechanical pointer is initially highlighting could be the first item on the list, or the last item on the list, an item denoting a saved position by preference, an item denoting a position chosen by software algorithm, the item that was activated last, or the item that was last highlighted by the user.

43. Device of claim 41 wherein the mechanical pointer can move to highlight the next or previous item position when a user action or movement is interpreted at the user's intent to move the pointer.

44. Device of claim 41 wherein, when the actual list is larger than the displayed area, a function allows the mechanical pointer to be moved past the beginning or the end of the list, whereafter items are removed or added to the ends of the list depending on the movement through the list.

45. Device of claim 41 wherein the mechanical pointer can be held static when user actions that show intent to move through the list change the digital display so that the mechanical pointer is highlighting the active item in the list.

46. Device of claim 41 wherein the digital display provide some visual cue highlight to augment the position of the mechanical pointer including but not limited to, scaling the highlighted item up or down in size, changing the color or shading of the highlighted item, animating the highlighted item, and reducing visibility of the non-highlighted items.

47. Device of claim 41 wherein user actions that are interpreted as an intent to move the mechanical pointer forward or backwards through the list is the tilting of the device with respect to gravity in one direction denoting the intent to move forward in the list, and/or tilting in the opposite direction denoting the intent to move backward in the list.

48. Device of claim 41 wherein user actions that are interpreted as an intent to move the mechanical pointer forward or backwards through the list is the touching of one touch sensitive area of the device denoting the intent to move forward in the list and/or touching a different touch sensitive area of the device denoting the intent to move backward in the list.

49. Device of claim 41 wherein user actions that are interpreted as an intent to move the mechanical pointer forward or backwards through the list is the pressing of one button denoting the intent to move forward in the list and/or touching a different button denoting the intent to move backward in the list.

50. Device of claim 41 wherein user actions that are interpreted as an intent to move the mechanical pointer forward or backwards through the list is the swiping across an array of touch sensitive areas of the device in one direction to denote the intent to move forward in the list and in the opposing direction denoting the intent to move backward in the list.

51. Device of claim 41 wherein user actions that are interpreted as an intent to move the mechanical pointer forward or backwards through the list is to tap the device with a finger on one side to denote the intent to move forward in the list and to tap device on an opposing side to denote the intent to move backward in the list.

52. Device of claim 41 wherein user actions that are interpreted as an intent to move the mechanical pointer forward or backwards through the list is covering one sensor that detects changes in visible or nonvisible light or covering a light emitter that will deprive a light sensor of visible or non-visible light.

53. Device of 41 wherein the user actions that are interpreted as an intent to move the mechanical pointer forward or backwards can be through computer interpretation of a sequence of visual data taken by an imaging camera or array of light sensitive devices in visible or non-visible light.

54. Device of 41 wherein the user actions that are interpreted as an intent to move the mechanical pointer forward or backwards can be through a rotational encoder that when rotated in a direction.

55. Device of 41 wherein user actions that are interpreted as an intent to move the mechanical pointer forward or backwards through the list is the user's finger or hand or other body part or stylus or other pointing device, moving over and through an array of spatial fields that can be used to detect the presence of the object, the direction of motion, the speed of motion, and the distance into the field.

56. Device of claim 1 wherein the device contains a projected capacitance apparatus that can detect the presence of the user's hand, fingers or other body parts or other objects without the need for physical contact.

57. Device of claim 41 wherein acceleration and velocity measurements over the time of the user actions are interpreted as intent to move the mechanical pointer and can be used to speed up or slow down the movement of the pointer to match the speed of the movement of the user for a more realistic feeling of control.

58. Device of claim 55 wherein the spatial field can be an electric field.

59. Device of claim 55 wherein the spatial field can be a magnetic field.

60. Device of claim 55 wherein the spatial field can be a projected capacitance field.

61. A device of claim 55 wherein changes in the field are measured over time and can be interpreted to calculate distance from the field apparatus, acceleration through the field, velocity of movement, and vector of movement.

62. Device of claim 1 wherein there is a plurality of fields that cover different adjacent areas of the device.

63. Device of claim 62 wherein said plurality of fields are used to detect the presence and motion of a user's hand, fingers, or other body parts, stylus or other objects as they move from field to field.

64. Device of claim 1 wherein the device contains a rotational encoder apparatus, the rotation of which by the user is interpreted by software to detect speed of rotation, acceleration of rotation, and distance of rotation.

65. Device of claim 1 wherein the display of the device has widgets for presenting additional information.

66. Device of claim 1 wherein the device has a button via which the menu of functions can be accessed and a collection of menu items are displayed on the digital display and the mechanical pointer points to the active item.

67. Device of claim 66, wherein each button press moves through a circular menu consisting of a collection of menu items, selecting the next item from the list.

68. Device of claim 1 a watch, such as a wrist-worn watch.

69. A method for time management in a system comprising a device with calendar functions, the method comprising,
storing events in the database of the calendar function in a time-chronological order, and
sending an alert of an event to the device, and
displaying the alert on the dial of the device by presenting context for the alert on a digital display part of the dial and by showing the time information of the event by means of the position and movement of a mechanical pointer.
